(19) United States
(12) Patent Application Publication
(10) Pub. No.: US 2015/0019245 A1
(43) Pub. Date: Jan. 15, 2015

(54) MEDICAMENT REGISTRATION APPARATUS AND METHOD

(71) Applicant: TOSHIBA TEC KABUSHIKI KAISHA, Tokyo (JP)

(72) Inventors: Toshihide Murata, Izunokuni-shi (JP); Hirokazu Watanabe, Tokyo-to (JP); Shiomi Matsui, Izunokuni-shi (JP); Makoto Nozawa, Shizuoka-ken (JP); Yoshiaki Kumai, Mishima-shi (JP); Maki Sato, Yokohama-shi (JP); Yumiko Okuma, Tokyo-to (JP); Shunichiro Kamamoto, Izunokuni-shi (JP); Ryu Morita, Mishima-shi (JP); Yasuhiro Nakajima, Izunokuni-shi (JP)

(21) Appl. No.: 14/326,676

(22) Filed: Jul. 9, 2014

(30) Foreign Application Priority Data
Jul. 11, 2013 (JP) 2013-145799

(51) Int. Cl. G06F 19/00

(52) U.S. Cl. CPC G06F 19/3456
USPC 705/2

(57) ABSTRACT

In accordance with one embodiment, a medicament registration apparatus for registering a used medicament in a storage section comprises a registration module configured to set a borrow resource for a used medicament borrowed from another place and register the borrow source in the storage section and a display control module configured to display a list of the registered medicaments on a display section and display the information indicating that the medicament is borrowed from another place corresponding to the medicament set with the borrow source.

### CROSS-REFERENCE TO RELATED APPLICATION

This application is based upon and claims the benefit of priority from Japanese Patent Application No. 2013-145799, filed Jul. 11, 2013, the entire contents of which are incorporated herein by reference.

### FIELD

Embodiments described herein relate to a medicament registration apparatus and a medicament registration method.

### BACKGROUND

Conventionally, several systems have been proposed to prevent the occurrence of errors such as taking a medicament by mistake and the like. For example, in the system described in Japanese Unexamined Patent Application Publication No. 2002-163357, the medicament information specified by the barcode attached to the container of a medicament prepared to be prescribed is compared with information of a medicament that should be prescribed to prevent a wrong use of the medicament.

In an operating room, a nurse collects the empty medicament containers the medicaments in which are used in a surgery after the surgery, manually records the result of the collection on the used medicaments on a slip and delivers the slip to a pharmaceutical department. Further, it occurs sometimes that medicaments excluding those assumed to be used in a surgery before the surgery and prepared in advance for the surgery or other medicaments must be used for an emergent treatment at an emergent medical site such as in an operating room and the like. Insufficient medicaments are sometimes borrowed from another place nearby the medical site, such as an operating room, a medicament preparation room, a storage locker and the like. The emergent borrow of medicaments is one of the reasons that makes the inventory management on the medicaments in a hospital difficult.

### BRIEF DESCRIPTION OF THE DRAWINGS

FIG. 1 is a block diagram illustrating the schematic configuration of a medicament management system according to an embodiment;

FIG. 2 is a front view illustrating the appearance of a medicament registration apparatus;

FIG. 3 is a block diagram illustrating the hardware constitution of the medicament registration apparatus;

FIG. 4 is a block diagram illustrating the functional components of the medicament registration apparatus;

FIG. 5 is a flowchart illustrating the flow of a used medicament registration processing carried out in the medicament registration apparatus;

FIG. 6 is an illustration diagram illustrating an example of a login screen;

FIG. 7 is an illustration diagram illustrating an example of a patient registration screen;

FIG. 8 is an illustration diagram illustrating an example of a medicament registration screen;

FIG. 9 is an illustration diagram illustrating an example of a medicament confirmation screen;

FIG. 10 is an illustration diagram illustrating an example of a medicament confirmation screen;

FIG. 11 is an illustration diagram illustrating an example of an editing screen;

FIG. 12 is an illustration diagram illustrating an example of a borrow source selection screen;

FIG. 13 is an illustration diagram illustrating an example of an editing screen;

FIG. 14 is an illustration diagram illustrating an example of a medicament confirmation screen;

FIG. 15 is an illustration diagram illustrating an example of a medicament confirmation screen; and

FIG. 16 is an illustration diagram illustrating an example of a borrow source setting screen.

### DETAILED DESCRIPTION

In accordance with one embodiment, a medicament registration apparatus which registers a used medicament in a storage section comprises a registration module and a display control module. The registration module sets a borrow resource for a medicament to be used borrowed from another place and registers the borrow source in the storage section. The display control module displays a list of registered medicaments on a display section and displays the information indicating that the medicament is borrowed from another place corresponding to the medicament set with the borrow source.

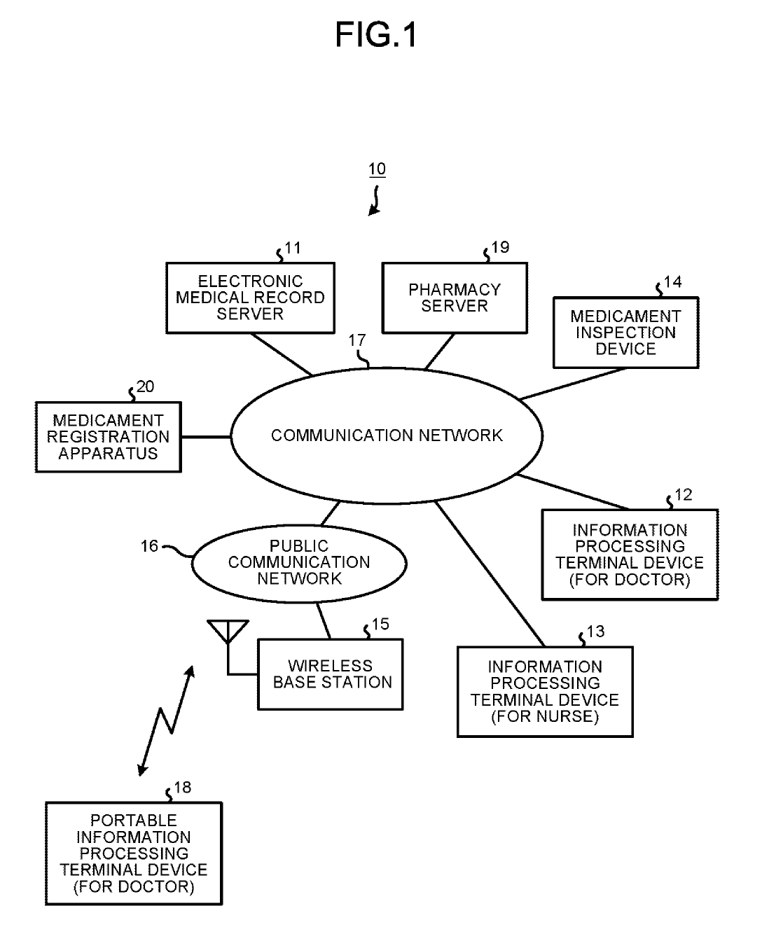

FIG. 1 is a block diagram illustrating the schematic configuration of a medicament management system 10 according to an embodiment. As shown in FIG. 1, the medicament management system 10 comprises an electronic medical record server 11, an information processing terminal device 12 for doctor, an information processing terminal device 13 for nurse, a medicament inspection device 14, a portable information processing terminal device 18 for doctor connected with a communication network 17 via a wireless base station 15 and a public communication network 16, a pharmacy server 19 and a medicament registration apparatus 20.

The electronic medical record server 11 is a device for managing and storing an electronic medical record. The information processing terminal device 12 for doctor is a device for recording an electronic medical record. The information processing terminal device 13 for nurse is a device for the reference to and the confirmation of the electronic medical record managed by the electronic medical record server 11. The medicament inspection device 14 is a device for supporting and inspecting the preparation of a medicament and the like based on the instruction information (e.g. prescription information) contained in the electronic medical record. The pharmacy server 19 is a device arranged in a pharmacy to manage a medicament delivery. Further, the pharmacy server 19 registers the medicament information (name, quantity, etc.) related to a medicament corresponding to the code information of the medicament or the external surface information (the feature amount indicating the label of the medicament or the feature amount indicating the surface states of the medicament such as surface hue, concave-convex state and the like) of the medicament in a table. The medicament registration apparatus 20 is an apparatus arranged in an operating room for supporting a nurse to register the medicaments used in a surgery or the medicaments emergently used by a nurse or pharmacist in an emergency. In the present embodiment, the medicament registration apparatus 20 is an apparatus arranged in an operating room and assumed to be used by a nurse to register the medicaments used in a surgery.

In the configuration above, the electronic medical record server 11, the information processing terminal device 12, the information processing terminal device 13, the medicament inspection device 14, the pharmacy server 19 and the medicament registration apparatus 20 are connected with the communication network 17.

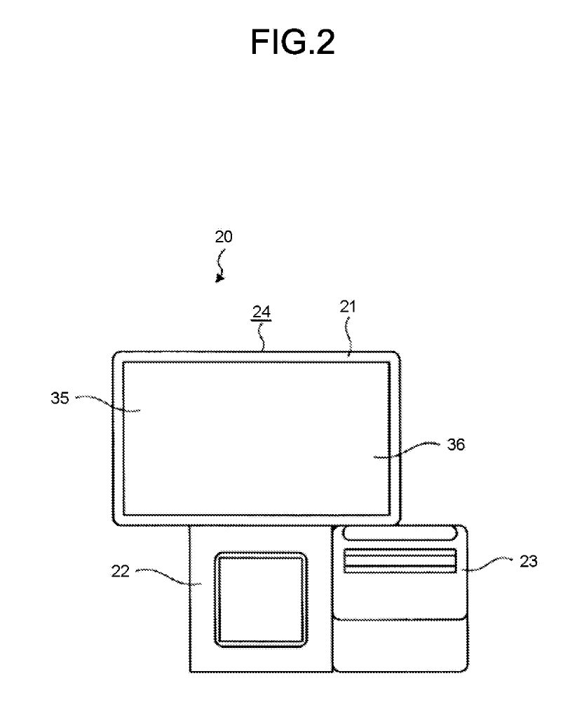

FIG. 2 is a front view illustrating the appearance of the medicament registration apparatus 20. As shown in FIG. 2, the medicament registration apparatus 20 roughly comprises an apparatus main body section 24 serving as the control main body of the medicament registration apparatus 20, a scanner 22 and a printer 23 for printing and outputting various kinds of information.

The apparatus main body section 24 comprises a touch panel display 21 for an operator, i.e., a nurse, to carry out various operations and for the display of various kinds of information including a list of used medicaments and the like.

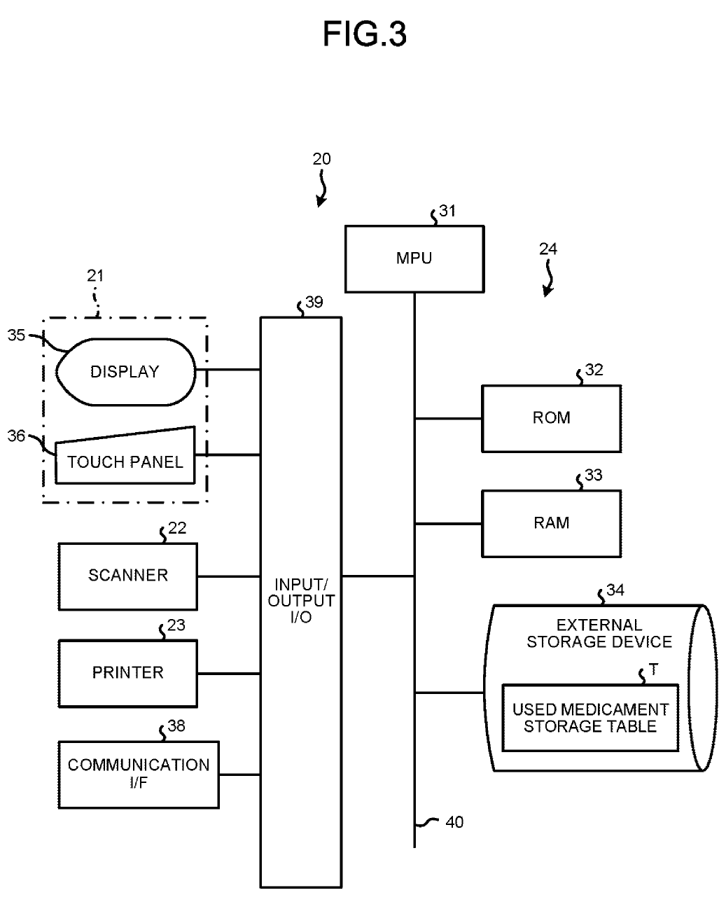

The scanner 22 comprises an image sensor (not shown) such as a color CCD (Charged Coupled Device) image sensor or a color CMOS (Complementary Metal-Oxide Semiconductor) image sensor and a light source (not shown) such as a LED (Light Emitting Diode). The scanner 22 photographs the image of the code symbol of a nurse ID (Identification), the code symbol of a patient ID, the code symbol of a medicament, a medicament and the like. The frame images (imaged images) sequentially photographed by the scanner 22 at a given frame rate are stored in the under-mentioned RAM (Random Access Memory) 33 (refer to FIG. 3).

Further, the scanner 22 may vertically stand on ground but is not limited to be placed on the table shown in FIG. 2.

Further, the medicament registration apparatus 20 may further comprise a scale for weighting a medicament and a RFID reader-writer for reading or writing data from or into the RFID (Radio Frequency Identification) attached to a medicament.

FIG. 3 is a block diagram illustrating the hardware constitution of the medicament registration apparatus 20. As shown in FIG. 3, a MPU (Micro Processing Module) 31 for controlling the whole medicament registration apparatus 20, a ROM (Read Only Memory) 32, a RAM 33, an external storage device 34 and a communication interface (I/F) 38 for carrying out a communication interface operation are arranged in the apparatus main body section 24 of the medicament registration apparatus 20. The ROM 32 stores various kinds of data, including control programs, in a non-volatile manner. The RAM 33 functions as a working area to store various kinds of data temporarily. The external storage device 34 consists of a hard disk drive capable of storing high-capacity data and control programs (such as a database and the like) and a SSD (Solid State Drive).

Here, the touch panel display 21, the scanner 22, the printer 23 and the communication interface 38 are connected with a bus line 40 via an input/output I/O 39. The bus line 40 is connected with the MPU 31, the ROM 32, the RAM 33 and the external storage device 34.

Further, the touch panel display 21 consists mainly of a display 35 serving as a display section and a touch panel 36.

Further, the external storage device 34 includes a used medicament storage table T in which the result of the collection on the medicaments used in a surgery is stored.

With such a structure, the MPU 31 of the medicament registration apparatus 20 operates according to the control programs stored in the ROM 32 and the external storage device 34 to carry out the registration support of the medicaments used in a surgery.

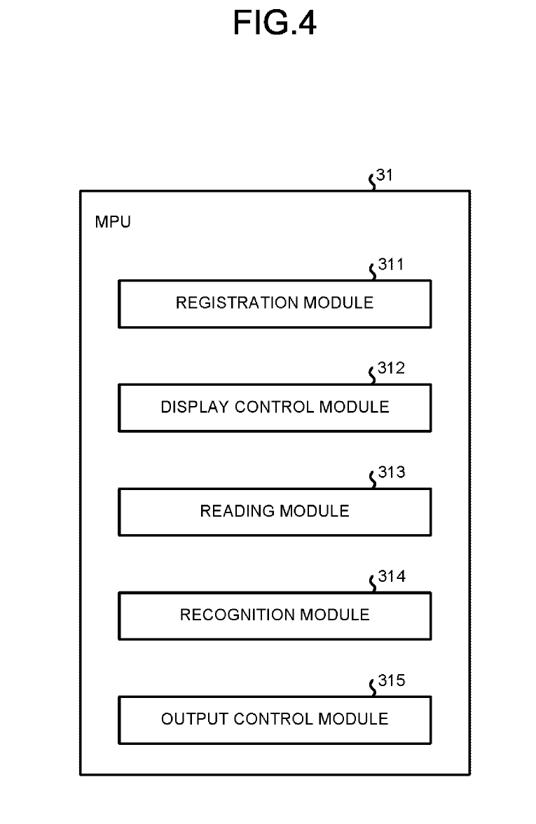

Next, the characteristic functions of the medicament registration apparatus 20 according to the present embodiment are described. FIG. 4 is a block diagram illustrating the functional components of the medicament registration apparatus 20. The MPU 31 operates according to the control programs stored in the ROM 32 and the external storage device 34 to function as a registration module 311, a display control module 312, a reading module 313, a recognition module 314 and an output control module 315, as shown in FIG. 4.

The reading module 313 reads the code information of the code symbol attached to a medicament used in a surgery or all or part of the external surface information (the feature amount indicating the label of the medicament or the feature amount indicating the surface states of the medicament, such as surface hue, concave-convex state and the like) of a medicament used in a surgery from the image scanned by the scanner 22. The detection processing of the code information according to a code symbol such as a barcode or a two-dimensional code can be carried out using the conventional technology and is therefore not described here.

Further, if the medicament registration apparatus 20 comprises a RFID reader-writer, the reading module 313 reads code information from the data read by the RFID reader-writer.

The recognition module 314 recognizes the medicament based on the code information or the external surface information (referred hereinafter to as medicament ID) as a reading result read by the reading module 313. Further, in a method of recognizing a medicament based on code information, the medicament information (name, quantity, etc.) of a medicament is stored in advance as a table corresponding to code information, and the medicament can be recognized by extracting the medicament information of the medicament based on the code information from the table. Further, in a method of recognizing a medicament based on external surface information (the feature amount indicating the label of a medicament or the feature amount indicating the surface states of a medicament such as surface hue, concave-convex state and the like), the external surface information of a medicament is stored as a table corresponding to code information in advance, and the medicament can be recognized by extracting the medicament information of the medicament based on the external surface information from the table.

The registration module 311 registers the medicament used in a surgery recognized by the recognition module 314 in the used medicament storage table T of the external storage device 34 functioning as a storage section. Further, the registration module 311 registers a medicament set with a borrow source in association with borrowing information containing the borrow source in the used medicament storage table T of the external storage device 34.

The display control module 312 displays the medicament information of the medicament registered by the registration module 311 and the like on the display 35 serving as a display section. Further, the display control module 312 displays each GUI (graphical user interface) related to medicament registration on the display 35.

The output control module 315 outputs a medicament slip on which detailed content (medicament ID, medicament information, quantity, etc.) of a registered medicament is recorded. Further, the output control module 315 outputs a borrow slip on which detailed content (medicament ID, medicament information, quantity, etc.) of a registered medicament set with a borrow source to each borrow source. Further, the medicament slip and the borrow slip may be sent to an external device via the communication network 17 to be output, but are not limited to be printed and output using the printer 23.

Next, a used medicament registration processing is described below which is carried out according to a control program by the MPU 31 of the medicament registration apparatus 20 according to the embodiment described above. The medicament registration apparatus 20 according to the embodiment scans the code symbol and the image of a medicament used in a surgery and carries out a used medicament registration processing after the surgery.

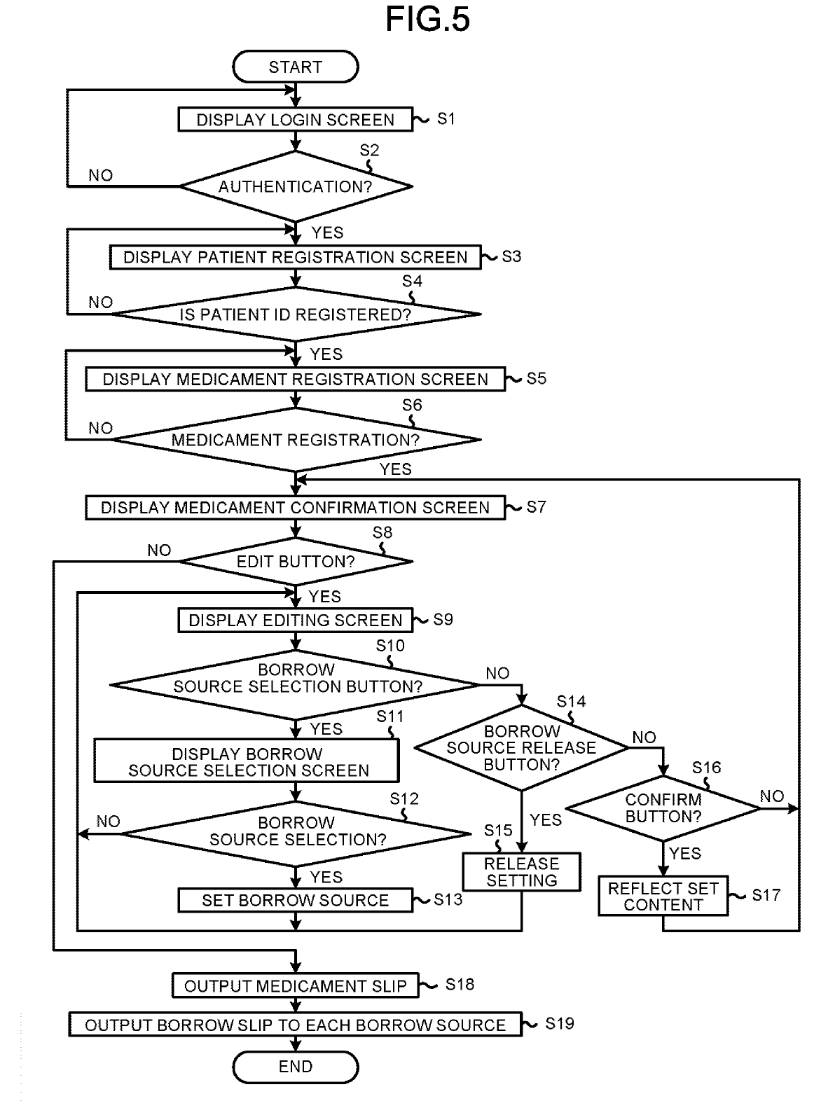

FIG. 5 is a flowchart illustrating the flow of a used medicament registration processing carried out by the MPU 31 of the medicament registration apparatus 20 according to a control program. As shown in FIG. 5, the MPU 31 of the medicament registration apparatus 20 displays a login screen on the display 35 as an initial state (ACT S1). Each operator (nurse) permitted to operate the medicament registration apparatus 20 has an ID card with which the operator can be authenticated to operate the medicament registration apparatus 20.

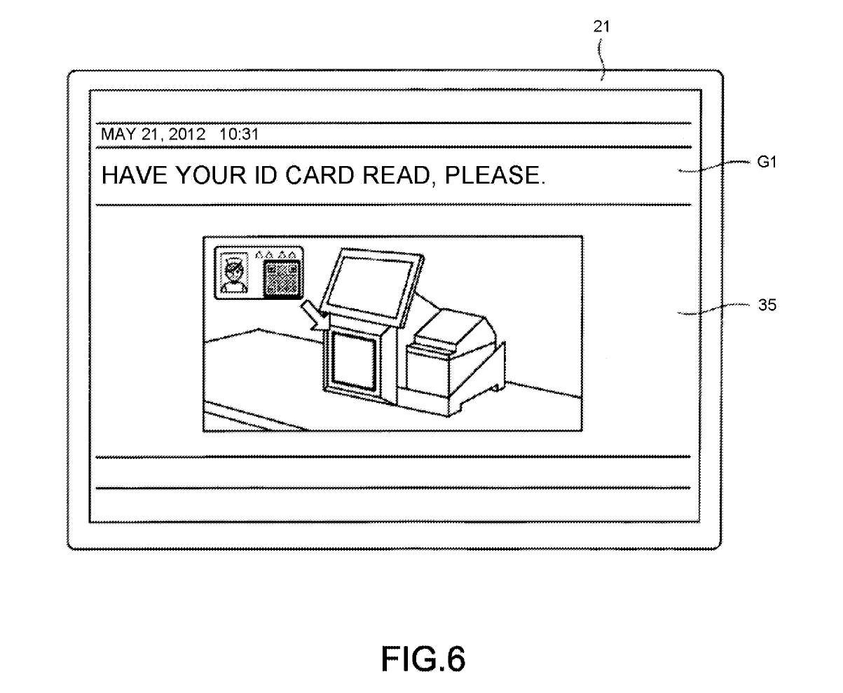

FIG. 6 is an illustration diagram illustrating an example of a login screen G1. A guide comment of ‘Have your ID card read, please.’ and a guide image for urging the scanner 22 to read the code symbol of the nurse ID attached to an ID card are displayed on the login screen G1, as shown in FIG. 6.

Thus, to carryout a login processing, the operator (nurse) holds the code symbol of the nurse ID attached to his/her ID card in front of the scanner 22 for the scanner 22 to read the nurse ID.

If the nurse ID is authenticated through a login processing (YES in ACT S2), the MPU 31 of the medicament registration apparatus 20 displays a patient registration screen G2 on the display screen of the display 35 (ACT S3). In addition, if the nurse ID is not authenticated (NO in ACT S2), the MPU 31 of the medicament registration apparatus 20 returns to ACT S1 to display the login screen G1 again.

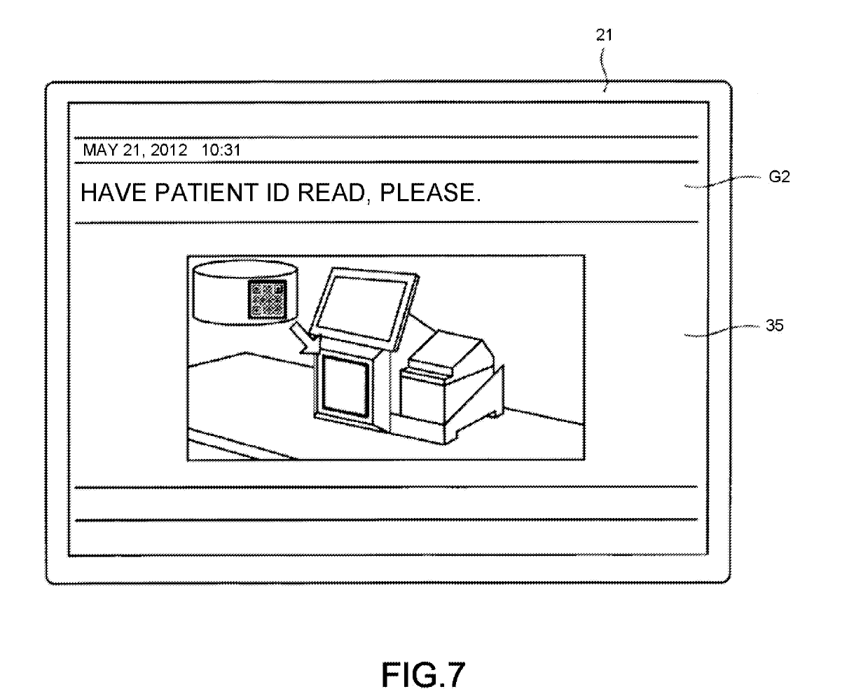

FIG. 7 is an illustration diagram illustrating an example of the patient registration screen G2. A guide comment of ‘Have a patient ID read, please.’ and a guide image for urging the scanner 22 to read the code symbol of the patient ID attached to the wristband of a patient are displayed on the patient registration screen G2, as shown in FIG. 7.

Thus, to carry out a patient registration processing, the operator (nurse) holds the code symbol of the patient ID attached to the wristband of the patient in front of the scanner 22 for the scanner 22 to read the patient ID.

If the patient ID is registered through a patient registration processing (YES in ACT S4), the MPU 31 of the medicament registration apparatus 20 displays a medicament registration screen G3 for the registration of a medicament additionally used in a surgery on the display screen of the display 35 (S5). In addition, if the patient ID is not registered (NO in ACT S4), the MPU 31 of the medicament registration apparatus 20 returns to ACT S3 to display the patient registration screen G2 again.

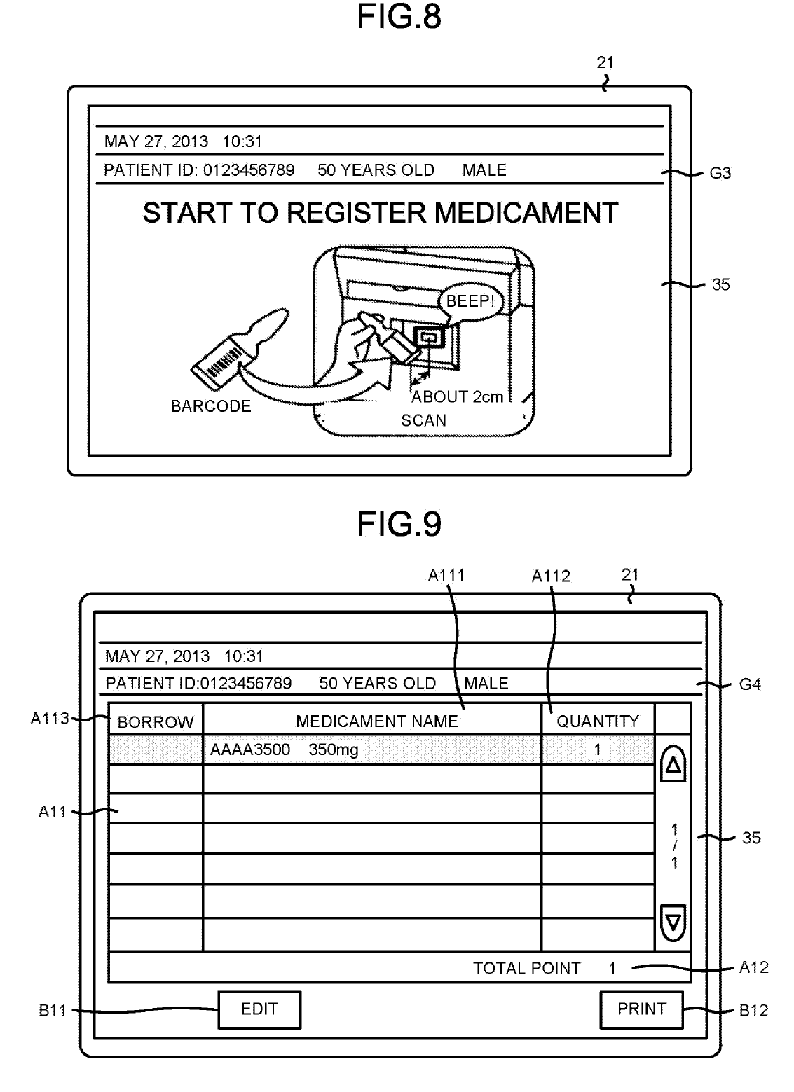

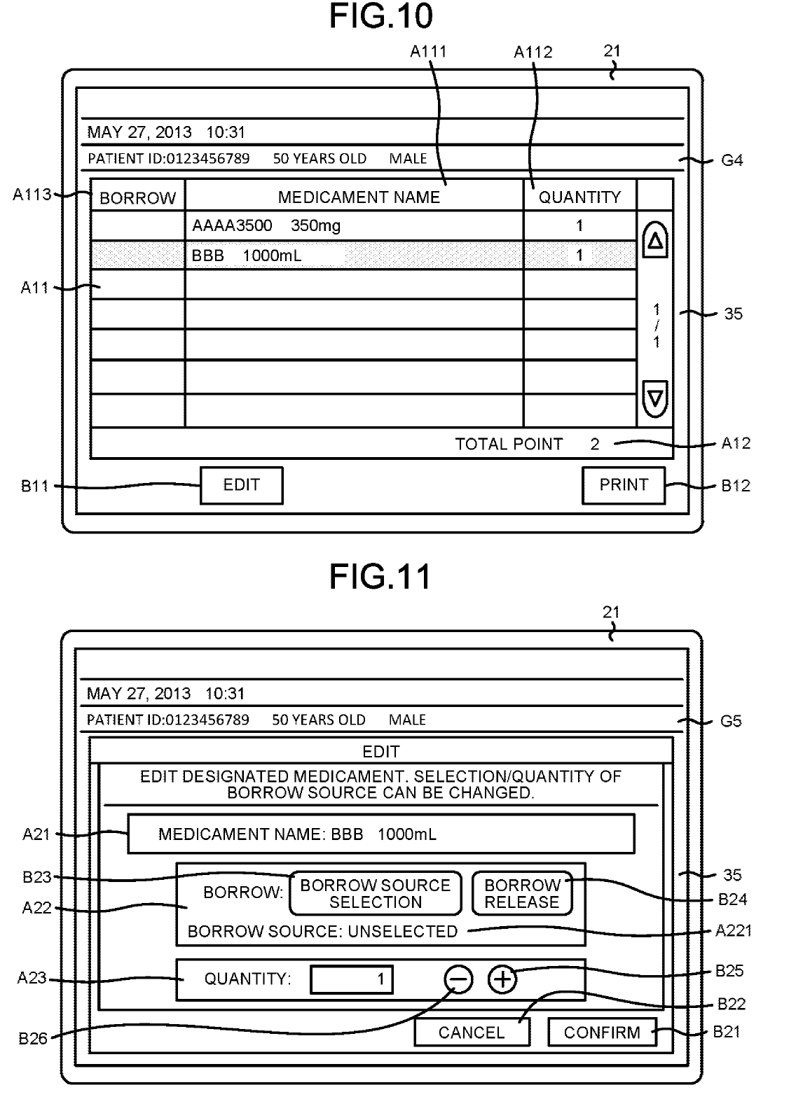

FIG. 8 is an illustration diagram illustrating an example of the medicament registration screen G3. A guide comment of ‘Start to register medicament’ and an image for urging the scanner 22 to read the code symbol of the medicament ID attached to a medicament are displayed on the medicament registration screen G3, as shown in FIG. 8. Further, the patient ID and patient information (e.g. age and gender) of the patient specified by the patient ID read from the patient registration screen G2 are also displayed on the medicament registration screen G3 (in the following figures, the patient ID and the patient information are all the same).

Thus, to carry out a medicament registration processing based on the medicament registration screen G3, the operator (nurse) holds the code symbol of the medicament ID attached to a medicament in front of the scanner 22 for the scanner 22 to read the medicament ID.

The MPU 31 of the medicament registration apparatus 20 enters a standby state until the medicament ID is read (NO in ACT S6). When the medicament ID is read, the MPU 31 of the medicament registration apparatus 20 registers the medicament ID and the medicament information and the quantity corresponding to the medicament ID in the used medicament storage table T (YES in ACT S6). Then, the MPU 31 of the medicament registration apparatus 20 displays a medicament confirmation screen G4 on the display screen of the display 35 (ACT S7). In addition, after ACT S7, the MPU 31 of the medicament registration apparatus 20 registers a new medicament ID every time a new medicament ID is read by the scanner 22 which continues to read a medicament ID in the background.

FIG. 9 is an illustration diagram illustrating an example of the medicament confirmation screen G4. The medicament confirmation screen G4 includes a list display column A11, a total point space A12, an Edit button B11 and a Print button B12. The list display column A11 includes a medicament name column A111 for displaying medicament information (name, quantity, etc.), a quantity column A112 for displaying a medicament quantity and a borrow column A113 for displaying a borrow icon which will be described later. In the list display column A11, the medicament information (name, quantity, etc.) and the quantity of a registered medicament obtained from the pharmacy server 19 are displayed in the medicament name column A111 and the quantity column A112, respectively. Further, the MPU 31 of the medicament registration apparatus 20 sums up the total quantity of the registered medicaments and displays the total quantity in the total point column A12 as a total point.

For example, when a new medicament ID is registered through a medicament registration processing, the MPU 31 of the medicament registration apparatus 20 additionally displays the medicament information of the medicament related to the new medicament ID on the list display column A11. Further, the MPU 31 of the medicament registration apparatus 20 explicitly presents the medicament information of a new registered medicament by highlighting the medicament information.

However, for an emergent treatment at a medical site such as in a surgery, insufficient medicaments are sometimes borrowed from another place nearby, such as an operating room, a medicament preparation room, a storage locker and the like. Thus, in the medicament registration apparatus 20 in the present embodiment, it is possible to set a borrow source for a medicament borrowed from another place using the GUI provided by the display control module 312.

The specific setting method is described as follows: first, the operator (nurse) designates a medicament borrowed from another place from the list of medicaments displayed in the list display column A11, that is, the registered medicaments, and operates (presses) the Edit button B11. The MPU 31 of the medicament registration apparatus 20 displays an editing screen G5 for editing (changing) the setting on the designated medicament on the display screen of the display 35 (ACT S9) when the designation on medicaments and the operation on the Edit button B111 are accepted (YES in ACT S8).

FIG. 11 is an illustration diagram illustrating an example of the editing screen G5. As shown in FIG. 11, the editing screen G5 includes a medicament information setting column A21 representing the medicament information (medicament name) of a designated medicament, a borrow setting column A22 for setting or cancelling a borrow source and a quantity setting column A23 representing a quantity. Further, the editing screen G5 includes a Confirm button B21 for indicating the confirmation on the edited content and a Cancel button B22 for indicating a cancel operation.

Here, the borrow setting column A22 includes a Borrow Source Selection button B23 indicating the selection on a borrow source and a Borrow Release button B24 indicating the cancellation of a borrow source. Further, the borrow setting column A22 includes a borrow source column A221 for representing a place where a borrow source is set.

In the borrow setting column A22, the MPU 31 of the medicament registration apparatus 20 displays a borrow source selection screen G6 for selecting a borrow source on the display screen of the display 35 (ACT S11) when the operation of the operator (nurse) on the Borrow Source Selection button B23 is accepted (YES in ACT S10).

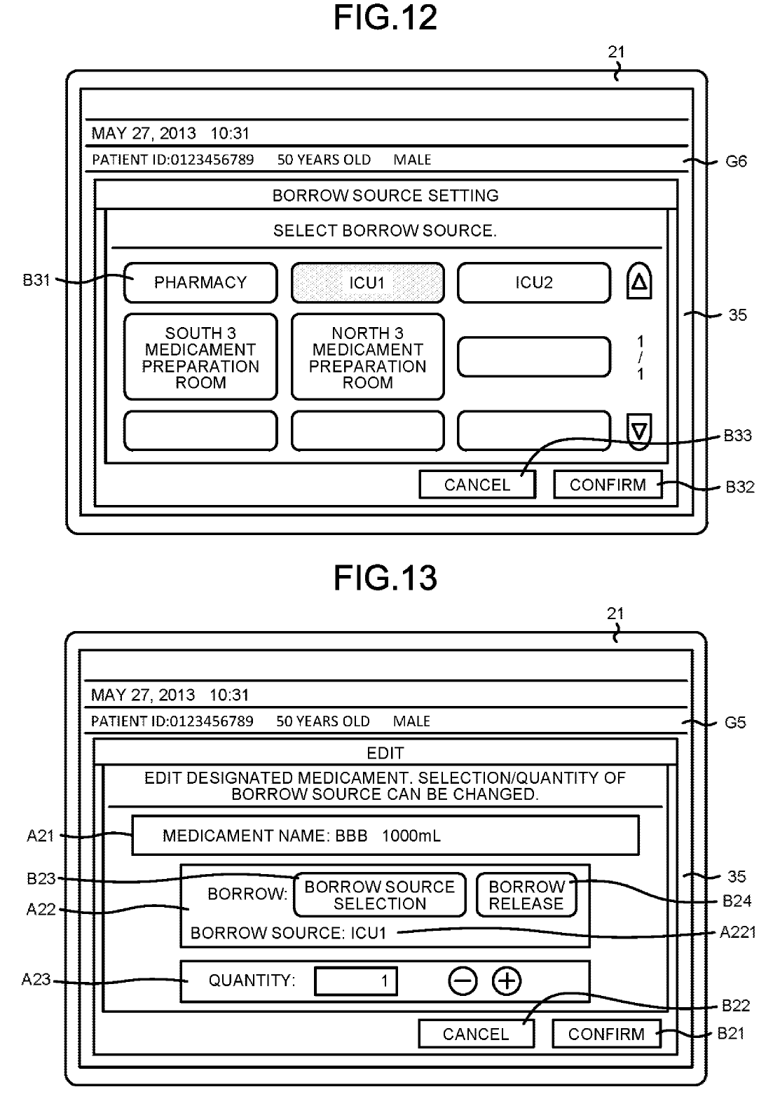

FIG. 12 is an illustration diagram illustrating an example of the borrow source selection screen G6. As shown in FIG. 12, the borrow source selection screen G6 includes Select buttons B31 for selecting another places (facilities) such as an operating room, a medicament preparation room and the like serving as a candidate for a borrow source. Further, the borrow source selection screen G6 includes a Confirm button B32 for indicating the confirmation on a borrow source and a Cancel button B33 for indicating a cancel operation.

Facility name information representing the facility names presented on the corresponding Select button B31 is set corresponding to each of the Select buttons B31 in advance. The operator (nurse) selects a Select button B31 corresponding to a medicament borrow source from the borrow source selection screen G6 and operates the Confirm button B32.

If the operation on the Confirm button B32 is accepted (YES in ACT S12) after the operation on an optional one of the Select buttons B31 is accepted, the MPU 31 of the medicament registration apparatus 20 sets the facility (facility name information) corresponding to the selected Select button B31 as a borrow source (ACT S13). Sequentially, the MPU 31 of the medicament registration apparatus 20 returns to ACT S9 to display the editing screen G5 shown in FIG. 13 on the display screen of the display 35 after the facility name (ICU1) of the set borrow source is input to the borrow source column A221. Further, when the Cancel button B33 is pressed (NO in ACT S12), the MPU 31 of the medicament registration apparatus 20 directly returns to ACT S9 to display the previous editing screen G5.

Further, when the operator (nurse) accepts the operation on the Borrow Release button B24 on the editing screen G5 (NO in ACT S10 and YES in ACT S14), the MPU 31 of the medicament registration apparatus 20 releases the set borrow source (ACT S15). Then, the MPU 31 of the medicament registration apparatus 20 returns to ACT S9 to display, on the display screen of the display 35, the editing screen G5 on which the borrow source column A221 is returned to a ‘unselected’ state (refer to FIG. 11).

When setting a borrow source and the like on the editing screen G5, the operator (nurse) confirms the edited content by pressing the Confirm button B21.

When the operation on the Confirm button B21 on the editing screen G5 is accepted (NO in ACT S10, NO in ACT S14 and YES in ACT S16), the MPU 31 of the medicament registration apparatus 20 reflects the content set on the editing screen G5 in the used medicament storage table T of the external storage device 34 (ACT S17). For example, when a borrow source is set, the borrowing information including the borrow source (facility name information) is registered corresponding to the medicament ID of a designated medicament. Further, when a borrow source is released, the borrowing information corresponded to the medicament ID of a designated medicament is deleted.

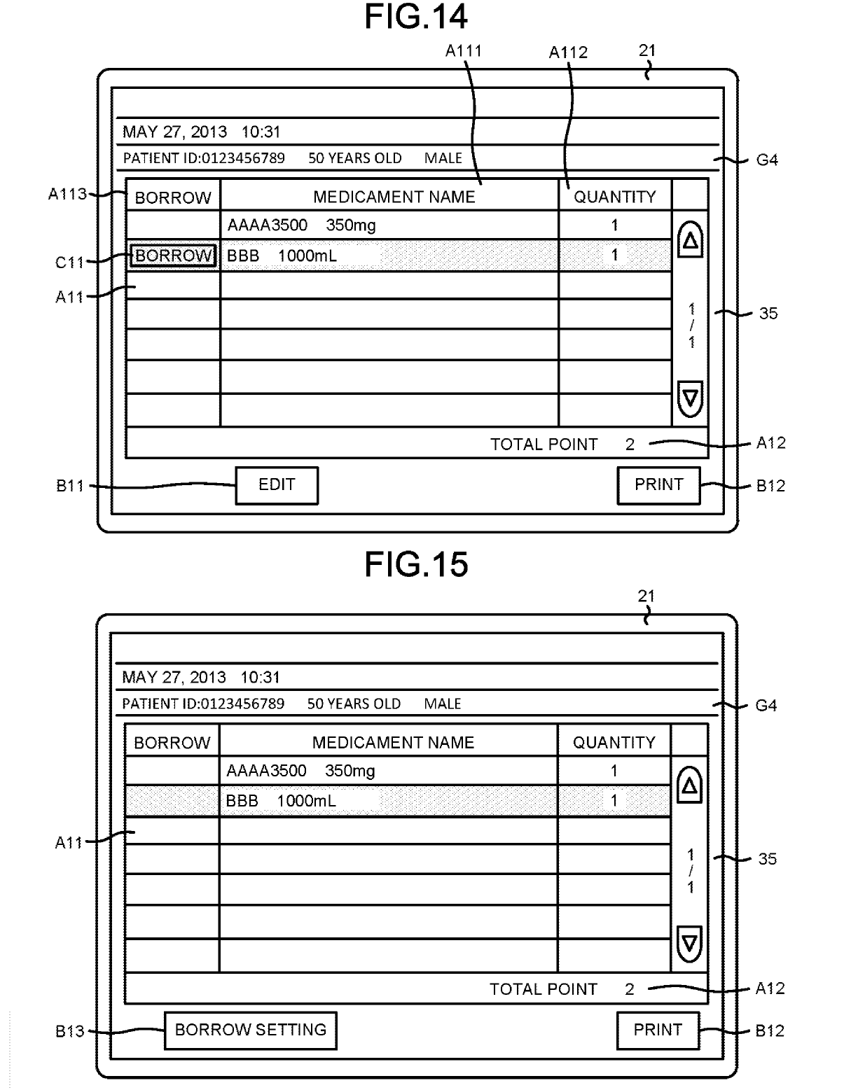

Then, the MPU 31 of the medicament registration apparatus 20 returns to ACT S7 to display a medicament confirmation screen. Further, when a borrow source is set on the editing screen G5, the MPU 31 of the medicament registration apparatus 20 displays information (hereinafter referred to as borrow icon) such as a character or graphic representing that a medicament is borrowed from another place corresponding to the medicament the borrow source for which is set on the medicament confirmation screen shown in FIG. 14.

FIG. 14 is an illustration diagram illustrating an example of the medicament confirmation screen. It is exemplified that on the medicament confirmation screen G4 shown in FIG. 14, a borrow icon C11 is represented in the borrow column A113 of a medicament (BBB 1000 mL) a borrow source for which is to be set. Besides, the borrow icon is not limited to be represented by the method exemplified in FIG. 14.

In this way, in the medicament registration apparatus 20 according to the present embodiment, a borrow source can be easily set for a registered medicament through the GUI displayed on the display screen of the display 35, thereby managing the medicament borrowed from another place more reliably. Further, as a borrow icon is displayed corresponding to a medicament borrowed from another place, thus it can be easily known which medicament is borrowed.

Further, on the editing screen G5, in addition to the setting or the release of a borrow source, the setting on medicament information and quantity can be changed by operating the medicament information setting column A21 and the button ‘+’ B25 or the button ‘−’ B26 on the quantity setting column A23. When the set medicament information and medicament quantity are changed on the editing screen G5, the MPU 31 of the medicament registration apparatus 20 reflects the changed content in the used medicament storage table T in ACT S17 and reflects and displays the changed content on the medicament confirmation screen G4 in the following ACT S9.

When the operation on the Cancel button B22 on the editing screen G5 is accepted (NO in ACT S10, NO in ACT S14 and NO in ACT S16), the MPU 31 of the medicament registration apparatus 20 clears the content set on the editing screen G5 and returns to ACT S7 to display the previous medicament confirmation screen G4.

On the medicament confirmation screen G4, the MPU 31 of the medicament registration apparatus 20 outputs a medicament slip on which the medicament ID, the medicament information and the quantity of a registered medicament are contained from the printer 23 (ACT S18) when the operation on the Print button B12 is accepted (NO in ACT S8). Next, the MPU 31 of the medicament registration apparatus 20 outputs a borrow slip on which the medicament ID, the medicament information and the quantity of a registered medicament set with a borrow source are contained from the printer 23 to each borrow source (ACT S19).

As stated above, the medicament registration apparatus 20 according to the present embodiment is capable of more reliably managing the medicament borrowed from another place during a surgery. Further, as a borrow slip on the borrowed medicaments is issued to each borrow source, the borrow service and the inventory management of a hospital can be effectively realized.

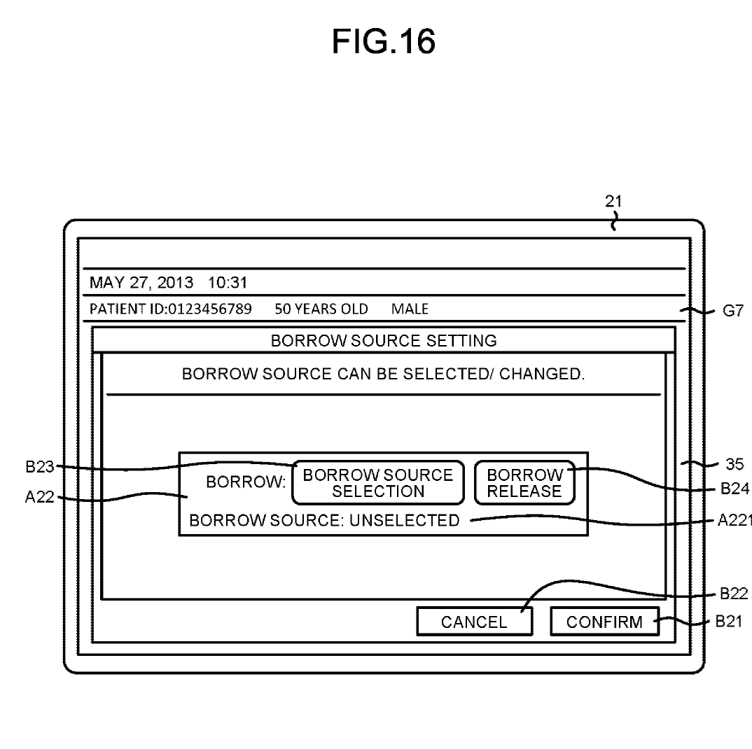

Further, in the aforementioned embodiments, a borrow source is set or released using the editing screen G5; however, the present invention is not limited to this. Alternatively, a dedicated GUI (borrow source setting screen) mainly used for setting or releasing a borrow source may be prepared. In this case, for example, a Borrow Setting button B13 may be set on the medicament confirmation screen G4, as shown in FIG. 15, and the borrow source setting screen G7 shown in FIG. 16 is displayed when the Borrow Setting button B13 is operated. Here, the borrow source setting screen G7 shown in FIG. 16 is a screen which is different from the editing screen G5 shown in FIG. 13 in including neither of the medicament information setting column A21 and the quantity setting column A23.

Further, in aforementioned embodiments, it is exemplified that a borrow source is set or released for each medicament; however, the present invention is not limited to this, a borrow source may be set or released for more than one medicaments. In this case, when the operation on the aforementioned Borrow Setting button B13 is accepted after a plurality of medicaments are designated in the list display column A11, the MPU 31 of the medicament registration apparatus 20 displays a borrow source setting screen G7 related to the designated multiple medicaments. Then, the MPU 31 of the medicament registration apparatus 20 sets or releases the borrow source related to the designated multiple medicaments according to the content operated on the borrow source setting screen G7.

In this way, a borrow source may be set or released for a plurality of medicaments, thus effectively managing the medicaments borrowed from other places.

Further, in aforementioned embodiments, a borrow source is set for a registered medicament, however, the present invention is not limited to this, a pre-selected borrow source may be set and registered for each medicament to be registered. In this case, the MPU 31 of the medicament registration apparatus 20 displays a borrow source setting screen G7 when the operation on the Borrow Setting button B13 is accepted in a state where no medicament is designated. Then, the MPU 31 of the medicament registration apparatus 20 sets a borrow source in advance after the selection on a borrow source according to the operation on the borrow source setting screen G7 is accepted. Then, borrowing information of a preset borrow source is registered corresponding to each medicament registered after the operation.

In this way, as a medicament may be automatically registered corresponding to a preset borrow source, thus the medicaments borrowed from other places can be effectively managed. Further, it is assumed that a preset release is carried out when the Borrow Release button B24 is operated on the borrow source setting screen G7 in a state where no medicament is designated.

The registration of a medicament additionally used in a surgery is described in the present embodiment; however, the present invention is not limited to this. For example, a medicament which may be additionally used in a surgery may be registered before a surgery in advance, which prevents a wrong use of a medicament before medicaments are administered.

Further, the control program executed by the medicament registration apparatus 20 in the present embodiment may be stored in an installable or executable file in a computer-readable recording medium such as CD-ROM, flexible disk (FD), CD-R, DVD (Digital Versatile Disk) and the like.

Further, the control program executed by the medicament registration apparatus 20 in the present embodiment may be stored in a computer connected with a network such as the Internet to be provided after being downloaded from the network or provided or distributed via a network such as the Internet and the like.

The control program executed by the medicament registration apparatus 20 in the present embodiment may be incorporated in a ROM and the like in advance.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A medicament registration apparatus for registering a used medicament in a storage section, comprising:
a registration module configured to set a borrow resource for a used medicament borrowed from another place and register the borrow source in the storage section; and
a display control module configured to display a list of the registered medicaments on a display section and display the information indicating that the medicament is borrowed from another place corresponding to the medicament set with the borrow source.

2. The medicament registration apparatus according to claim 1, wherein
the display control module displays a selection screen for selecting a borrow source on the display section; and
the registration module sets a borrow source selected from the selection screen.

3. The medicament registration apparatus according to claim 1, wherein
the registration module sets a borrow source for a designated medicament from the medicaments displayed in a list and registers the borrow source.

4. The medicament registration apparatus according to claim 1, wherein
the registration module sets and registers a pre-selected borrow source for each medicament of a registration target.

5. The medicament registration apparatus according to claim 1, further comprising:
an output control module configured to output a slip related to the medicaments registered in the storage section and set with a borrow source to each borrow source.

6. A method for a medicament registration apparatus for registering a used medicament in a storage section, including:
setting a borrow resource for a used medicament borrowed from another place and registering the borrow source in the storage section; and
displaying a list of registered medicaments on a display section and the information indicating that the medicament is borrowed from another place corresponding to the medicament set with the borrow source.
